(19) United States
(12) Patent Application Publication
(10) Pub. No.: US 2026/0046543 A1
(43) Pub. Date: Feb. 12, 2026

(54) NOVELTY SPEAKER

(71) Applicant: Adrian Hubbard, Suwanee, GA (US)

(72) Inventor: Adrian Hubbard, Suwanee, GA (US)

(21) Appl. No.: 18/799,943

(22) Filed: Aug. 9, 2024

(51) Int. Cl. H04R 1/02

(52) U.S. Cl. CPC H04R 1/023; H04R 2201/02

(57) ABSTRACT

Implementations of a novel speaker are provided. In some implementations, the speaker of the present disclosure is configured to produce sounds waves corresponding to a sound associated with an appearance of the speaker when the speaker is powered on, paired with another device, or connected to a network. In some implementations, the outer body of the speaker of the present disclosure is formed in the shape of a human body having a torso, arms, hands, legs, feet, and a head. In some implementations, all of the controls for the speaker are not visible from the front side of the speaker.

### TECHNICAL FIELD

This disclosure relates to implementations of a wireless speaker.

### BACKGROUND

There exist mascot speakers, but these speakers are limited in functionality and design.

### BRIEF DESCRIPTION OF THE DRAWINGS

FIGS. 1-8 illustrates various views of an implementation of an example speaker according to the present disclosure.

FIG. 9-10 is an exploded view of an example portion of the example speaker illustrated in FIGS. 1-8.

FIG. 11 is an exploded view of another example portion of the example speaker illustrated in FIG. 3.

FIG. 12 illustrates an implementation of an example environment of a speaker according to the present disclosure.

FIG. 13 illustrates an example computer system, which may be used with implementations of the present disclosure.

### DETAILED DESCRIPTION

Implementations of a novel speaker are provided. In some implementations, the speaker is a wireless speaker. In some implementations, the speaker is a BLUETOOTH speaker. In some implementations, the speaker is a portable speaker. In some implementations, the speaker is a bookshelf speaker. In some implementations, the speaker is a smart speaker.

In some implementations, the speaker of the present disclosure is configured to function as a speaker. In some implementations, the speaker of the present disclosure is configured to pair with another device such as a smartphone, computer, or tablet to receive audio signals from the paired device and convert those signals into sound. In some implementations, the speaker of the present disclosure is configured to connect to a Wi-Fi network to receive audio signals. In some implementations, a speaker of the present disclosure is configured to connect with another speaker of the present disclosure.

As explained in more detail below, in some implementations, the speaker of the present disclosure is configured to produce sounds waves corresponding to a sound associated with an appearance of the speaker when the speaker is powered on, paired with another device, or connected to a network.

In some implementations, the speaker of the present disclosure comprises an outer body forming an enclosure for housing or enclosing speaker components. For example, in some implementations, the outer body is configured to house or enclose speaker drivers. In some implementations, the outer body is configured to house or enclose a receiver. In some implementations, the outer body is configured to house or enclose a power source.

In some implementations, the outer body is rigid. In some implementations, the outer body is durable. In some implementations, the outer body is made from a plastic. In some implementations, the outer body is made from any suitable material.

In some implementations, the outer body also includes openings configured for sound waves to pass through the outer body from the speaker drivers housed in the enclosure.

In some implementations, the outer body of the speaker of the present disclosure is configured to house manual control buttons or touch controls (“controls”) for, for example, power, volume, pairing, and other functions. For example, in some implementations, the outer body of the speaker of the present disclosure is configured to house volume control buttons. In some implementations, the outer body of the speaker of the present disclosure is configured to house a power button. In some implementations, the outer body of the speaker of the present disclosure is configured to house other controls button for music control functions such as backwards and forward controls.

In some implementations, the outer body of the speaker of the present disclosure includes a charging port. In some implementations, the outer body of the speaker of the present disclosure includes a USB-C charging port. In some implementations, the charging port is used to charge a rechargeable battery enclosed inside the enclosure formed by the outer body.

In some implementations, the outer body of the speaker of the present disclosure is formed in the shape of a human body having a torso, arms, hands, legs, feet, and a head.

In some implementations, the head is the form of a stylized animal's head while the torso, arms, hands, legs, and feet resemble a human body.

In some implementations, the head, torso, arms, hands, legs, and feet resemble a human body.

In some implementations, the body or a portion of the body (e.g., the arms) has a muscular appearance.

In some implementations, the speaker is configured to produce sound waves corresponding to a sound associated with the animal or person (e.g., the sound the animal or person makes) represented by the stylized head when the speaker is powered on, paired with another device, or connected to a network.

In some implementations, the head portion of the outer body is interchangeable. In some implementations, the speaker is configured to produce sound waves corresponding to a sound based on the head portion selected and connected to the remainder of the speaker.

In some implementations, the speaker is configured to produce sound waves corresponding to a sound associated with the overall appearance of the speaker when the speaker is powered on, paired with another device, or connected to a network.

In some implementations, the openings in the outer body configured for sound waves to pass through from the speaker drivers housed in the enclosure are at a position corresponding to the torso area formed by the outer body.

In some implementations, at least some of the controls for the speaker (e.g., the volume controls, backwards and forward controls, and/or power button) are strategically configured and positioned so as to help conceal the controls. In some implementations, all of the controls for the speaker (e.g., the volume controls, backwards and forward controls, and/or power button) are strategically configured and positioned so as to help conceal the controls. In some implementations, all of the controls for the speaker (e.g., the volume controls, backwards and forward controls, and/or power button) are not visible from the front.

In some implementations, the controls, or at least some of the controls, are housed in the outer body of the speaker at a position corresponding to the elbow area of the arms formed by the outer body.

In some implementations, the charging port is positioned on the outer body of the speaker at a position corresponding to the back of one of the legs.

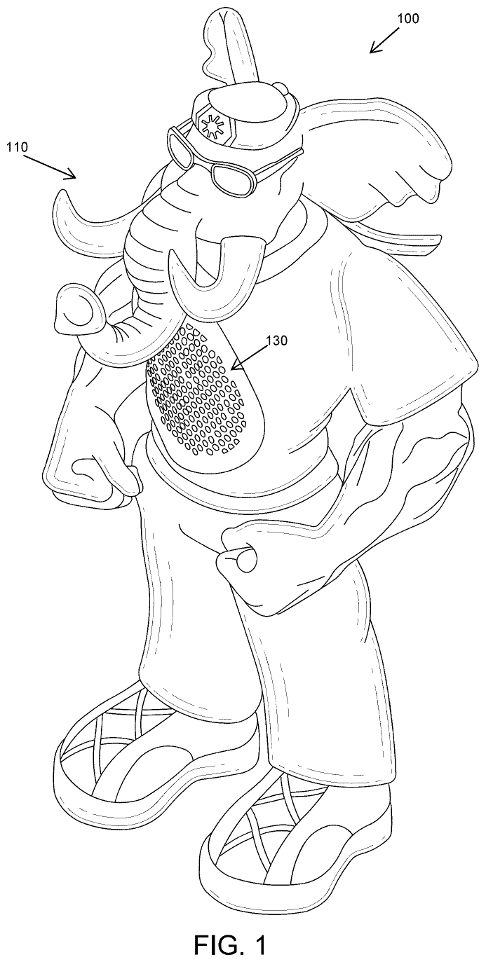

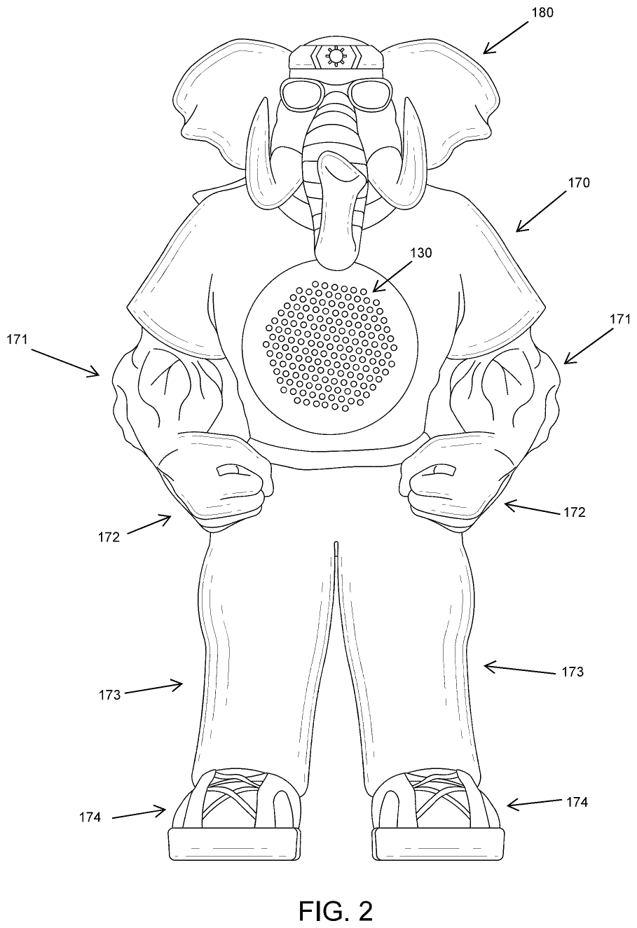

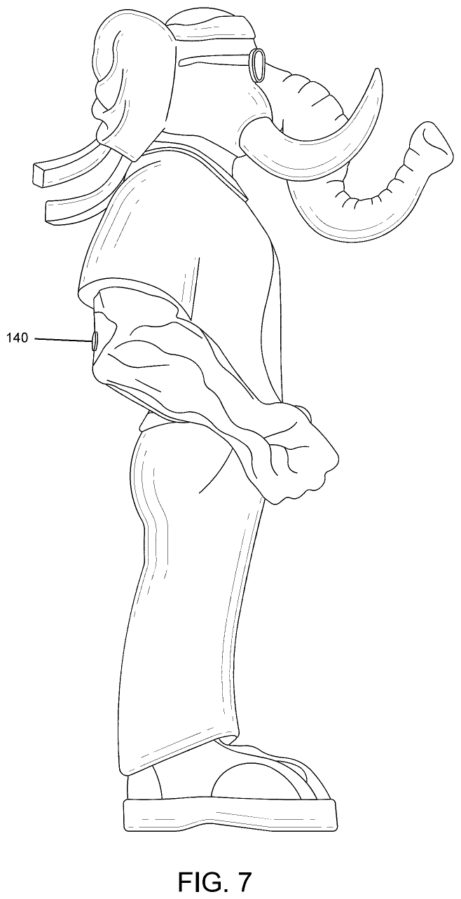

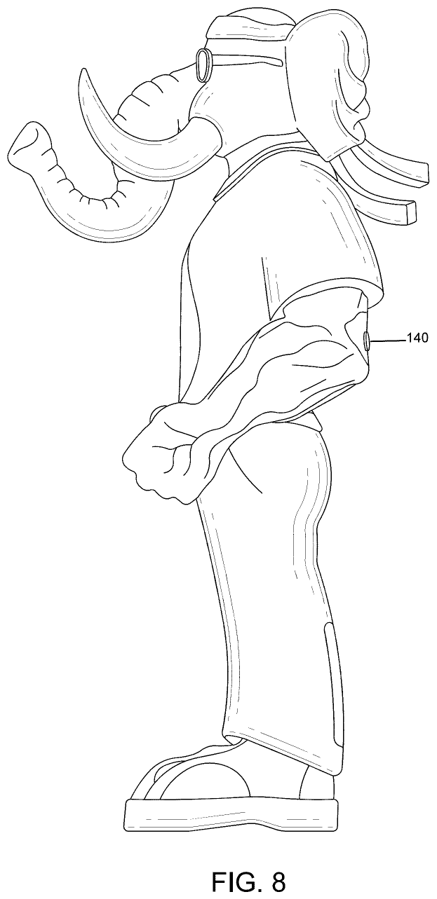

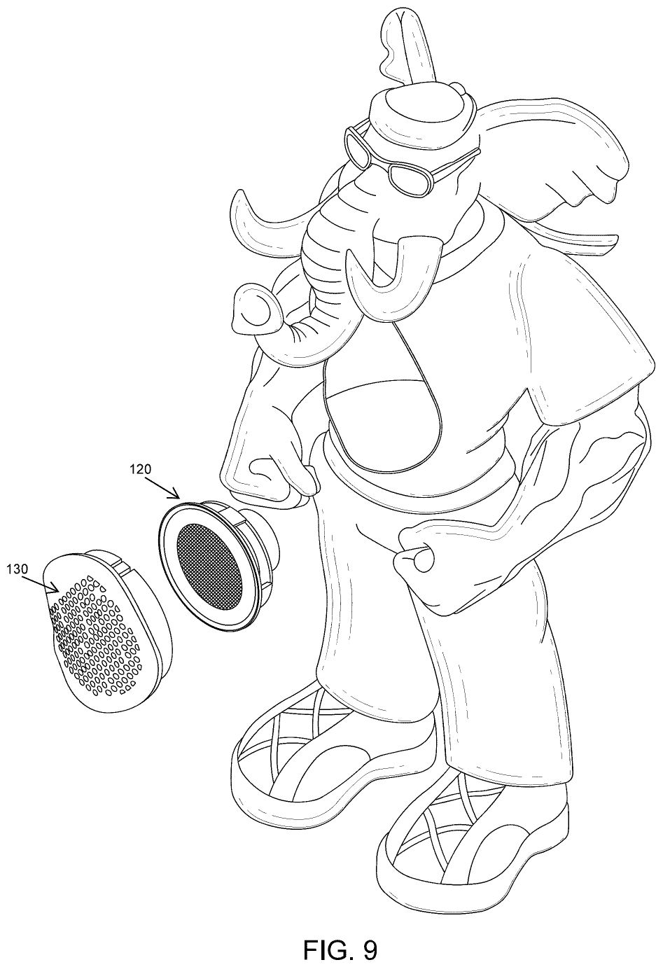

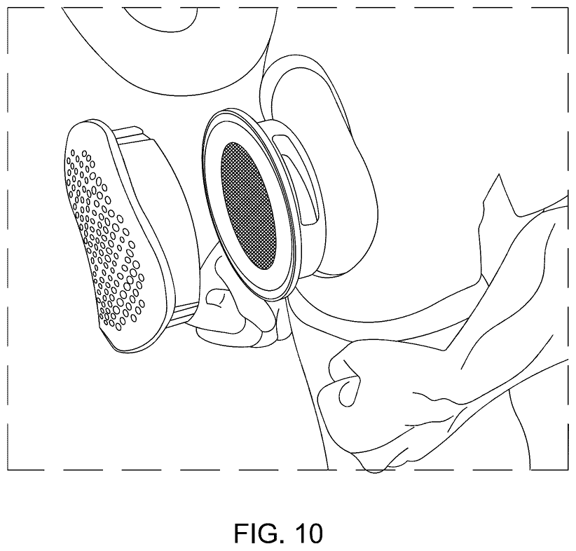

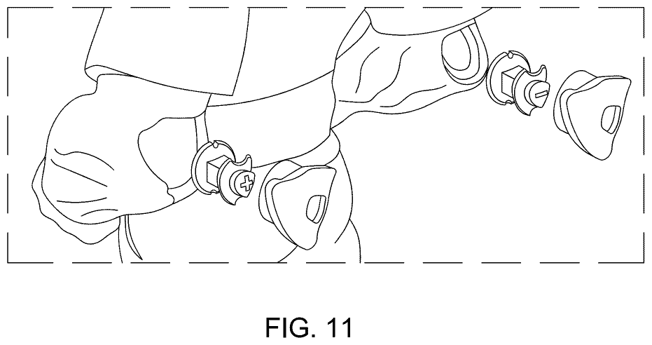

FIGS. 1-11 illustrates various views of an implementation of an example speaker 100 according to the present disclosure. As shown in FIGS. 1-8, in some implementations, the speaker 100 comprises an outer body 110 forming an enclosure for housing or enclosing speaker components. For example, in some implementations, as shown in FIGS. 9 and 10, the outer body 110 is configured to house or enclose speaker drivers 120.

In some implementations, the outer body 110 also includes openings 130 configured for sound waves to pass through the outer body from the speaker drivers 120 housed in the enclosure. In some implementations, the openings 130 are formed on a detachable cover as shown in FIG. 9. In some implementations, the openings 130 are integral to the outer body 110.

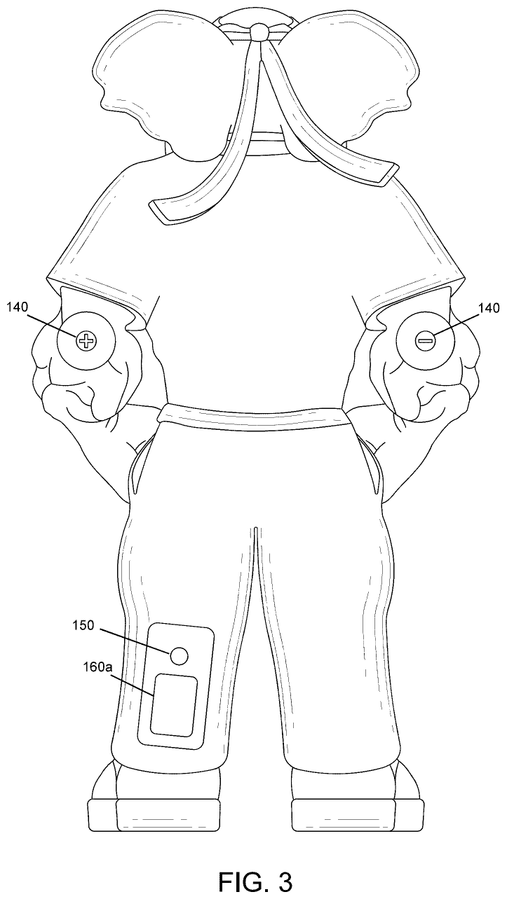

In some implementations, the outer body 110 of the speaker 100 of the present disclosure is configured to house manual control buttons or touch controls (“controls”) for, for example, power, volume, pairing, and other functions. For example, as shown in FIG. 3, in some implementations, the outer body 110 of the speaker 100 of the present disclosure is configured to house volume control buttons 140. In some implementations, the outer body 110 of the speaker 100 of the present disclosure is configured to house a power button 150. In some implementations, the outer body 110 of the speaker of the present disclosure is configured to house other controls button for music control functions such as backwards and forward controls.

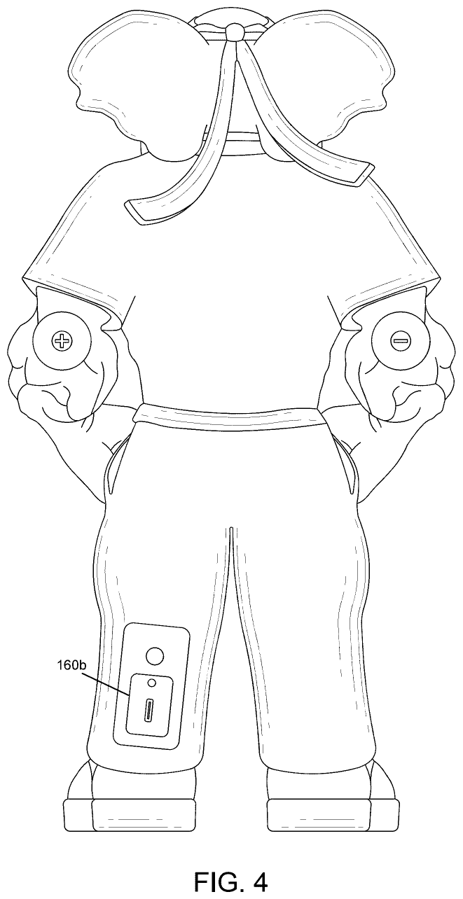

As shown in FIGS. 3 and 4, in some implementations, the outer body 110 of the speaker of the present disclosure includes a charging port 160a, 160b. In some implementations, the outer body of the speaker of the present disclosure includes a USB-C charging port 160b. In some implementations, the charging port 160a, 160b is used to charge a rechargeable battery enclosed inside the enclosure formed by the outer body.

In some implementations, the outer body of the speaker of the present disclosure is formed in the shape of a human body having a torso 170, arms 171, hands 172, legs 173, feet 174, and a head 180.

In some implementations, the head 180 is the form of a stylized animal's head while the torso, arms, hands, legs, and feet resemble a human body.

In some implementations, the head, torso, arms, hands, legs, and feet resemble a human body.

In some implementations, the body or a portion of the body (e.g., the arms) has a muscular appearance.

In some implementations, the speaker is configured to produce sound waves corresponding to a sound associated with the animal or person represented by the stylized head 180 when the speaker is powered on, paired with another device, or connected to a network.

In some implementations, the head portion 180 of the outer body is interchangeable. In this way, the speaker 100 may be customized. For example, in some implementations, one may choose from a group of head portions each having a different appearance to be used as the head portion 180 of the outer body 110.

In some implementations, the speaker is configured to produce sound waves corresponding to a sound based on the head portion selected and connected to the remainder of the outer body.

In some implementations, the speaker is configured to produce sound waves corresponding to a sound associated with the overall appearance of the speaker when the speaker is powered on, paired with another device, or connected to a network.

In some implementations, the openings 130 in the outer body configured for sound waves to pass through from the speaker drivers housed in the enclosure are at a position corresponding to the torso area 170 formed by the outer body 100.

In some implementations, a logo, design, number, or other indicia may be printed, engraved, or otherwise indicated in the torso area 170 formed by the outer body 100. In some implementations, the indicia are indicated over the openings 130. In some implementations, the cover having the openings 130 and/or, in some implementations, the indicia is interchangeable. In this way, the speaker 100 may be customized. For example, one may choose from a group of covers each having different indicia on the cover to be inserted in an opening of the outer body 110 as shown in FIG. 9.

In some implementations, the speaker is configured to produce sound waves corresponding to a sound based on the cover selected and connected to the remainder of the outer body.

In some implementations, the speaker is configured to produce sound waves corresponding to a sound based on the head portion and cover selected and connected to the remainder of the outer body.

As shown in FIG. 1, in some implementations, all of the controls for the speaker are not visible from the front. As shown in FIG. 3, in some implementations, all of the controls and auxiliary inputs/outputs (such as charging ports) for the speaker are positioned on the back of the outer body.

As shown in FIGS. 3, 7, 8 and 11, in some implementations, the controls, or at least some of the controls (such as the volume control buttons 140), are housed in the outer body of the speaker at a position corresponding to the elbow area (or adjacent or near the elbow area) of the arms formed by the outer body. In some implementations, the controls, or at least some of the controls (such as the volume control buttons 140), are housed in the outer body of the speaker at a position corresponding to the back of the arms formed by the outer body. In some implementations, the controls, or at least some of the controls (such as the volume control buttons 140), are housed in the outer body of the speaker at a position corresponding to the elbow area (or adjacent or near the elbow area) of the arms formed by the outer body so as to conceal or camouflage the controls such the controls resemble or mimic the protrusion of the elbows when the arms are bent.

In some implementations, the charging port 160a, 160b is positioned on the outer body of the speaker at a position corresponding to the back of one of the legs.

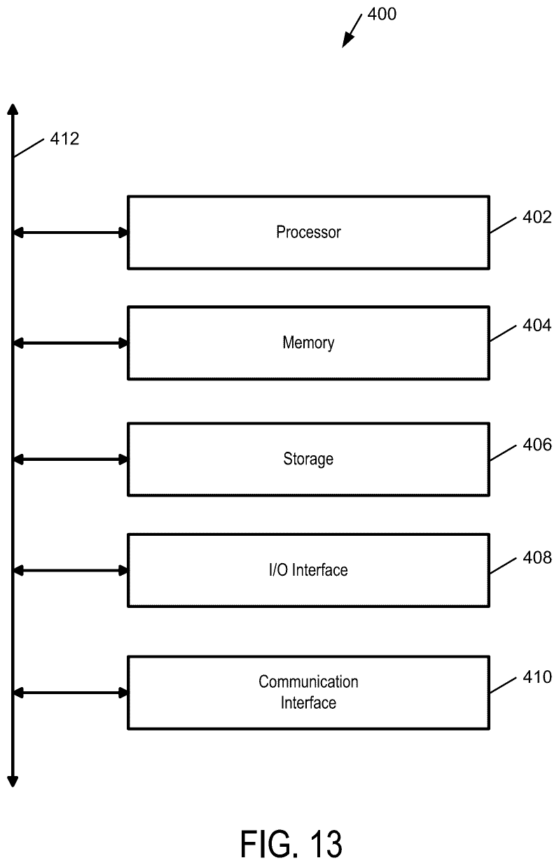

In some implementations, the speaker 100 may further comprise a computer system such as described below with respect to FIG. 13.

In some implementations, the speaker 100 is or is about 10 inches in height. The variation in height from 10 inches can be due to manufacturing variances. In some implementations, the speaker 100 is greater than 10 inches in height. In some implementations, the speaker 100 is less than 10 inches in height.

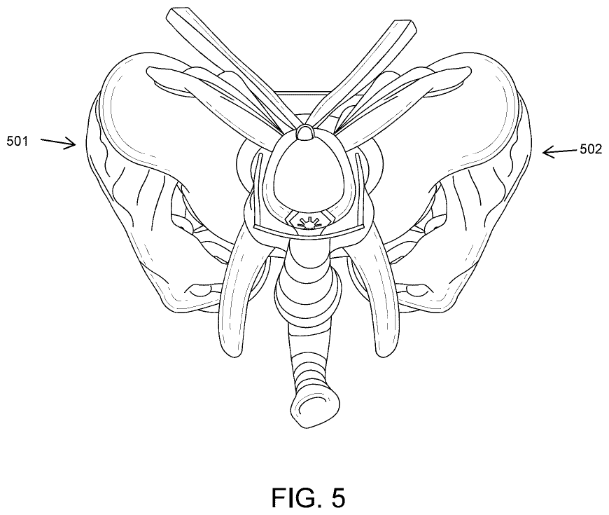

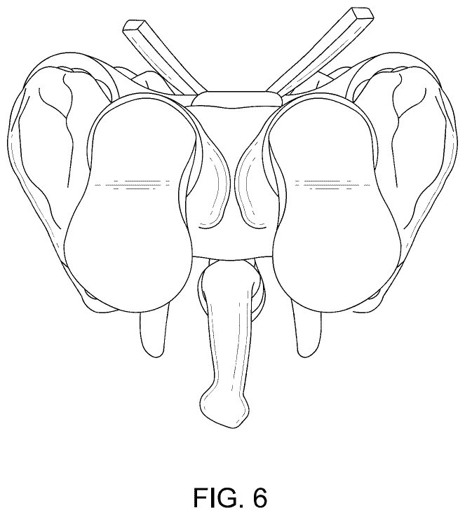

Referring to FIGS. 5 and 6, which illustrate a top and bottom view, respectively, of the speaker 100, in some implementations, the speaker 100 is or is about 5.43 inches in width from a first side 501 to a second side 502. The variation in width from 5.43 inches can be due to manufacturing variances. In some implementations, the speaker 100 is greater than 5.43 inches in width. In some implementations, the speaker 100 is less than 5.43 inches in width.

As discussed above, in some implementations, the speaker 100 is configured to produce sound waves corresponding to a sound associated with the animal or person represented by the stylized head 180 when the speaker is powered on, paired with another device, or connected to a network. For example, for speaker 100 illustrated in FIG. 1, in some implementations, the speaker is configured to produce sound waves corresponding to a sound associated with an elephant (e.g., the sound an elephant makes) when the speaker is powered on, paired with another device, or connected to a network.

As discussed above, in some implementations, the speaker 100 is configured to produce sound waves corresponding to a sound associated with the overall appearance of the speaker 100 when the speaker is powered on, paired with another device, or connected to a network. For example, if the appearance of the speaker is representative of a known organization (e.g., school), then in some implementations, the speaker is configured to produce sound waves corresponding to a sound (e.g., a jiggle, slogan, cheer, or other sound) associated with the organization when the speaker is powered on, paired with another device, or connected to a network. For example, the appearance of the speaker of FIG. 1 may be representative of The University of Alabama as the speaker has the appearance of its mascot. Thus, the speaker may be configured to make the sound of the widely used “Roll Tide” cheer when the speaker is powered on, paired with another device, or connected to a network.

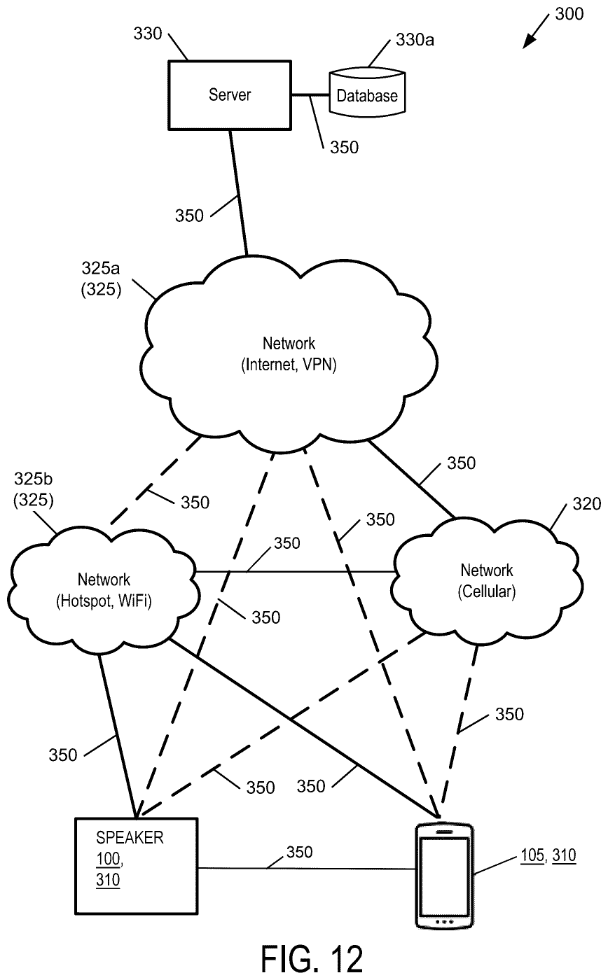

FIG. 12 illustrates an implementation of an example environment 300 of a speaker 100 according to the present disclosure.

As shown in FIG. 12, in some implementations, the environment 300 may include one or more client devices 310 (e.g., a speaker 100, a pairing device 105), a wireless cellular network 320, a network 325 (e.g., an Internet/VPN network 325a and a hotspot/Wi-Fi/captive-Wi-Fi network 325b), and one or more servers 330. In some implementations, the environment 300 may also include one or more data storage 330a linked to the server 330.

One of the client devices 310 is depicted as a pairing device 105 in the form of the smartphone, but the pairing device 105 may comprise any type of computing device, such as a desktop computer system, a laptop, cellular phone, a smart device, a mobile telephone, a tablet-style computer, or any other device capable of wireless or wired communication. In some implementations, pairing device 105 is configured to interact with the speaker 100 via an application, such as a web browser or a native application, residing on the pairing device.

In some implementations, the client devices 310 include hardware, software, or embedded logic components or a combination of two or more such components and is configured to carry out the appropriate functions implemented or supported by the client devices 310.

In some implementations, the client devices 310 may include one or more processors, one or more memories, one or more displays, one or more interfaces, one or more components capable of inputting data, one or more components capable of outputting data, one or more components capable of communicating with any other component of the environment 300 or any other component suitable for a particular purpose.

In some implementations, the client devices 310 are configured to access networks 320 and/or 325. In some implementations, the client devices 310 are configured to communicate with servers 330.

In some implementations, the client device 310 can connect to the network 325 through a wireless cellular network 320, such as GPRS-based and CDMA-based wireless networks, as well as 802.16 WiMax and long-range wireless data networks.

In some implementations, components of the environment 300 may communicate with any other component of the environment 300 over network 325. Network 325 may be any suitable network. In some implementations, for example, one or more portions of network 325 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 325, or a combination of two or more of the foregoing.

In some embodiments, components of the environment 300 may be configured to communicate over links 350. Links 350 may connect components of the environment 300 to networks 320, 325 or to each other. In some implementations, one or more links 350 may include one or more wireline (such as for example Digital Subscriber Line (DSL) or Data Over Cable Service Interface Specification (DOCSIS)), wireless (such as for example BLUETOOTH, Wi-FiM or Worldwide Interoperability for Microwave Access (WiMAX)), or optical (such as for example Synchronous Optical Network (SONET) or Synchronous Digital Hierarchy (SDH)) links. In particular embodiments, one or more links 350 may each include an ad hoc network such as BLUETOOTH, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 350. Links 350 may or may not be the same throughout the environment 300.

In some implementations, the server devices 330 may include a processor, memory, user accounts, and one or more modules to perform various functions such as those described above.

In some implementations, each server 330 may be a unitary server or may be a distributed server spanning multiple computers or multiple datacenters. Servers 330 may be of various types, such as, for example and without limitation, web server, file server, application server, exchange server, database server, or proxy server. In some implementations, each server 330 may include hardware, software, or embedded logic components or a combination of two or more such components for carrying out the appropriate functionalities implemented or supported by server 330. For example, a web server is generally capable of hosting websites containing web pages or particular elements of web pages. More specifically, a web server may host HTML files or other file types, or may dynamically create or constitute files upon a request, and communicate them to clients 310 in response to HTTP or other requests from clients 310. A database server is generally capable of providing an interface for managing data stored in one or more data stores.

In some implementations, one or more data storages 330a may be communicatively linked to one or more servers 330, respectively, via one or more links 350. In some implementations, data storages 330a may be used to store various types of information. In some implementations, the information stored in data storages 330a may be organized according to specific data structures. In particular embodiment, each data storage 330a may be a relational database. Particular embodiments may provide interfaces that enable servers 330 or clients 310 to manage, e.g., retrieve, modify, add, or delete, the information stored in data storage 330a.

FIG. 13 illustrates an example computer system 400, which may be used with some implementations of the present invention. This disclosure contemplates any suitable number of computer systems 400.

This disclosure contemplates computer system 400 taking any suitable physical form. In some implementations, as an example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 400 may include one or more computer systems 400; be unitary or distributed; span multiple locations; span multiple machines; or reside in a cloud, which may include one or more cloud components in one or more networks.

In some implementations, where appropriate, one or more computer systems 400 may perform without substantial spatial or temporal limitation one or more steps of one or more methods described or illustrated herein. In some implementations, as an example and not by way of limitation, one or more computer systems 400 may perform in real time or in batch mode one or more steps of one or more methods described or illustrated herein. In some implementations, one or more computer systems 400 may perform at different times or at different locations one or more steps of one or more methods described or illustrated herein, where appropriate.

In some implementations, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In some implementations, processor 402 includes hardware for executing instructions, such as those making up a computer program. In some implementations, as an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406.

In some implementations, processor 402 may include one or more internal caches for data, instructions, or addresses. The present disclosure contemplates processor 402 including any suitable number of any suitable internal caches, where appropriate. In some implementations, as an example and not by way of limitation, processor 402 may include one or more instruction caches, one or more data caches, and one or more translation look-aside buffers (TLBs).

In some implementations, instructions in the instruction caches may be copies of instructions in memory 404 or storage 406, and the instruction caches may speed up retrieval of those instructions by processor 402.

In some implementations, data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data.

In some implementations, the data caches may speed up read or write operations by processor 402. In some implementations, the TLBs may speed up virtual-address translation for processor 402.

In some implementations, processor 402 may include one or more internal registers for data, instructions, or addresses. The present disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In some implementations, memory 404 includes main memory for storing instructions for processor 402 to execute or data for processor 402 to operate on. In some implementations, as an example and not by way of limitation, computer system 400 may load instructions from storage 406 or another source (such as, for example, another computer system 400) to memory 404.

In some implementations, processor 402 may then load the instructions from memory 404 to an internal register or internal cache. In some implementations, to execute the instructions, processor 402 may retrieve the instructions from the internal register or internal cache and decode them.

In some implementations, during or after execution of the instructions, processor 402 may write one or more results (which may be intermediate or final results) to the internal register or internal cache. In some implementations, processor 402 may then write one or more of those results to memory 404.

In some implementations, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

In some implementations, one or more memory buses (which may each include an address bus and a data bus) may couple processor 402 to memory 404. In some implementations, bus 412 may include one or more memory buses, as described below.

In some implementations, one or more memory management units (MMUs) reside between processor 402 and memory 404 and facilitate accesses to memory 404 requested by processor 402.

In some implementations, memory 404 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 404 may include one or more memories 404, where appropriate. Although this disclosure describes and illustrates particular memory, this disclosure contemplates any suitable memory.

In some implementations, storage 406 includes mass storage for data or instructions. In some implementations, as an example and not by way of limitation, storage 406 may include an HDD, a floppy disk drive, flash memory, an optical disc, a magneto-optical disc, magnetic tape, or a Universal Serial Bus (USB) drive or a combination of two or more of these.

In some implementations, storage 406 may include removable or non-removable (or fixed) media, where appropriate. In some implementations, storage 406 may be internal or external to computer system 400, where appropriate. In some implementations, storage 406 is non-volatile, solid-state memory.

In some implementations, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form.

In some implementations, storage 406 may include one or more storage control units facilitating communication between processor 402 and storage 406, where appropriate. In some implementations, where appropriate, storage 406 may include one or more storages 406. Although this disclosure describes and illustrates particular storage, this disclosure contemplates any suitable storage.

In some implementations, I/O interface 408 includes hardware, software, or both providing one or more interfaces for communication between computer system 400 and one or more I/O devices. In some implementations, computer system 400 may include one or more of these I/O devices, where appropriate.

In some implementations, one or more of these I/O devices may enable communication between a person and computer system 400. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 408 for them.

In some implementations, where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In some implementations, communication interface 410 includes hardware, software, or both providing one or more interfaces for communication (such as, for example, packet-based communication) between computer system 400 and one or more other computer systems 400 or one or more networks.

In some implementations, as an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it.

In some implementations, as an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 400 may include any suitable communication interface 410 for any of these networks, where appropriate. In some implementations, communication interface 410 may include one or more communication interfaces 410, where appropriate. Although this disclosure describes and illustrates a particular communication interface, this disclosure contemplates any suitable communication interface.

In some implementations, bus 412 includes hardware, software, or both coupling components of computer system 400 to each other. In some implementations, as an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 412 may include one or more buses 412, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S. C. § 101. Herein, reference to a computer-readable storage medium excludes transitory forms of signal transmission (such as a propagating electrical or electromagnetic signal per se) to the extent that they are not eligible for patent protection under 35 U.S. C. § 101.

This disclosure contemplates one or more computer-readable storage media implementing any suitable storage. In some implementations, a computer-readable storage medium implements one or more portions of processor 402 (such as, for example, one or more internal registers or caches), one or more portions of memory 404, one or more portions of storage 406, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of a speaker system.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A speaker comprising:
an outer body forming an enclosure wherein:
the outer body is configured to enclose speaker drivers;
the outer body is configured to house volume control buttons and a power button;
the outer body includes a charging port;
the outer body is formed in the shape of a human body having a torso portion, arm portions, hand portions, leg portions, feet portions, and a head portion;
the outer body includes openings on a front side of the outer body through a torso portion of the outer body wherein the openings are configured for sound waves to pass through the outer body from the speaker drivers housed in the enclosure;
the head portion of the outer body is interchangeable,
the speaker is configured to produce sound waves corresponding to a sound based on the head portion selected, the speaker being configured to produce the sound waves when the head portion is connected to the remainder of the speaker and the speaker is powered on, paired with another device, or connected to a network; and
the volume control buttons, a power button, and charging port are positioned on a back side of the outer body, opposite the front side of the outer body.

2. The speaker of claim 1 further comprises a detachable cover that is interchangeable wherein the openings configured for sound waves to pass through the outer body from the speaker drivers housed in the enclosure are formed on the detachable cover.

3. The speaker of claim 1 wherein the speaker is a BLUETOOTH speaker.

4. The speaker of claim 1 wherein the head portion corresponds to the head of an animal while the torso portion, arm portions, hand portions, leg portions, and feet portions resembles a human body.

5. The speaker of claim 1 wherein the colors, shape, and one or more other characteristics of the outer body along with the sound are associated with a mascot.

6. The speaker of claim 1 wherein the volume control buttons are positioned near an area corresponding to an elbow area of the arm portions, respectively, of the outer body.

7. The speaker of claim 1 wherein the volume control buttons are positioned adjacent an area corresponding to an elbow area of the arm portions, respectively, of the outer body.

8. The speaker of claim 1 wherein the charging port is positioned on a leg portion of the outer body.

9. The speaker of claim 1 wherein all of the controls for the speaker are not visible from the front side of the outer body.

10. The speaker of claim 1 wherein all of the controls for the speaker are positioned on the back side of the outer body.

11. The speaker of claim 1 wherein the speaker is no more than 11 inches in height and no more than 6 inches in width.

12. A speaker comprising:
an outer body forming an enclosure wherein:
the outer body is configured to enclose speaker drivers;
the outer body is configured to house volume control buttons and a power button;
the outer body includes a charging port;
the outer body is formed in the shape of a human body having a torso portion, arm portions, hand portions, leg portions, feet portions, and a head portion;
the outer body includes openings on a front side of the outer body through a torso portion of the outer body wherein the openings are configured for sound waves to pass through the outer body from the speaker drivers housed in the enclosure;
the speaker is configured to produce sound waves corresponding to a sound based on the head portion when the speaker is powered on, paired with another device, or connected to a network; and
all of the controls for the speaker are positioned on a back side of the outer body, opposite the front side of the outer body.

13. A speaker comprising:
an outer body forming an enclosure wherein:
the outer body is configured to enclose speaker drivers;
the outer body is configured to house volume control buttons and a power button;
the outer body includes a charging port;
the outer body is formed in the shape of a human body having a torso portion, arm portions, hand portions, leg portions, feet portions, and a head portion;
the outer body includes openings on a front side of the outer body through a torso portion of the outer body wherein the openings are configured for sound waves to pass through the outer body from the speaker drivers housed in the enclosure;
the head portion of the outer body is interchangeable,
the speaker is configured to produce sound waves corresponding to a sound based on the head portion selected, the speaker being configured to produce the sound waves when the head portion is connected to the remainder of the speaker and the speaker is powered on, paired with another device, or connected to a network;
the volume control buttons and charging port are positioned on a back side of the outer body, opposite the front side of the outer body;
the volume control buttons are positioned adjacent an area corresponding to an elbow area of the arm portions, respectively, of the outer body; and
the charging port is positioned on a leg portion of the outer body.

14. A method of using the speaker of claim 2 comprising:
selecting from a group of head portions each having a different appearance to be used as the head portion of the outer body;
selecting from a group of covers configured to be inserted in an opening of the outer body where each cover has a different indicia on the cover and has openings formed on the cover configured for sound waves to pass through the cover from the speaker drivers housed in the enclosure when the cover is inserted in the opening of the outer body;
attaching the selected head portion to the speaker; and
attaching the selected cover to the speaker;
pairing the speaker with another device to produce sound waves corresponding to a sound based on the head portion selected and/or cover selected; and
using the speaker as a speaker.
